(19) United States
(12) Patent Application Publication
(10) Pub. No.: US 2004/0096807 A1
(43) Pub. Date: May 20, 2004

(54) Drawing book with stencils

(76) Inventor: Laura T. McGannon, Spring Lake, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/294,323

(22) Filed: Nov. 14, 2002

(51) Int. Cl. G09B 11/00

(52) U.S. Cl. 434/87

(57) ABSTRACT

A stenciling device that holds a plurality of stencils and drawing sheets together in a unitary, compact format that can be easily manipulated, handled and held by a child and which allows multiple uses of each of the stencils, and/or allows completed drawings to be easily removed, all without adult supervision, includes a plurality of stencil pages and one or more drawing pages, wherein the stencil pages and drawing pages are bound together. In accordance with another aspect of the invention, the stenciling device includes a plurality of stencil pages and a plurality of drawing pages, wherein the drawing pages include a line of perforations adjacent the bound edge of the device or book which allows individual drawing pages to be easily removed by tearing along the line of perforations.

### FIELD OF THE INVENTION

This invention relates to devices that facilitate drawing, printing and/or writing, and more particularly to devices utilizing stencils.

### BACKGROUND OF THE INVENTION

The use of stencils as a learning tool, especially for children, has been widely recognized. In particular, it has been suggested that stenciling is a valuable exercise that provides visual, tactile and kinesthetic experiences that are useful for developing hand-eye coordination, and for learning drawing, printing and writing skills. There are many creative examples of stencils and templates that are employed in activities which are fun and educational for children.

However, a problem with the use of stencils for amusing and/or educating children is that individual stencils and individual drawing sheets must be found and gathered together for these activities. This may easily become inconvenient and possibly frustrating if the child cannot find drawing paper and/or the desired stencils. Further, a child may find it difficult and frustrating to properly arrange and hold a loose stencil and a loose sheet of paper while manipulating a drawing or writing implement.

Several attempts have been made to overcome the above disadvantages. For example, U.S. Pat. No. 2,201,479 discloses a stencil book wherein the stencils and the drawing sheets are bound together in a book so that the stencils are automatically held in the proper position with respect to at least some of the drawing sheets. It is disclosed that the advantages are accomplished without loss of the multiple use of stencils since the stencils are arranged so that they may be shifted to two or more drawing sheets, permitting a portion of a figure to be printed or imposed on a drawing sheet. The ability to use the stencils with two or more drawing sheets is achieved by use of leaves having a common binding line, wherein each leaf has an extension folded approximately along the edge line of the book and having a stencil flap cut from the leaf and foldably connected to the extension so that it is adapted to be positioned for use adjacent opposite sides of another leaf. This arrangement has several disadvantages. First, it requires a considerable amount of folding and manipulation in order to fully exploit its potential for utilizing the stencil with multiple drawing sheets. Such manipulation may be difficult, especially for smaller children who may otherwise derive the greatest potential benefit from stenciling exercises. Another problem with the stencil book disclosed in this patent is that completed drawings cannot be easily removed from the book, i.e., the stencil book does not include any mechanism that would facilitate easy removal of completed drawings. A further disadvantage is that a relatively large work surface is needed for full use of each of the leaf extensions. For example, it is practically impossible to draw on a leaf extension using the stencil, while also using the front or back cover of the book as a writing surface.

U.S. Pat. No. 1,425,597 discloses a picture making apparatus having a support, a guide sheet hinged to the support, and a tablet supporting a picture receiving sheet, wherein the tablet is hinged to the support on an axis removed from that of the guide sheet. The device or book is used by opening the book to the guide sheet or stencil that is selected for reproduction, raising the selected stencil, folding the tablet down on the remaining leaves or stencils, and then folding the selected stencil down from the other direction to a superposed position upon the tablet. While easier to use then the stencil book described in U.S. Pat. No. 2,201,479, the picture making apparatus described in U.S. Pat. No. 1,425,597 is still relatively complicated and requires a degree of manipulation that may be difficult for children, especially younger children that might otherwise benefit the most from the stenciling exercises. In addition, the configuration of the picture making apparatus described in this patent requires a considerable amount of space for manipulating the tablet into a desired position beneath the selected stencil. Further, any non-selected stencils above the selected stencil, and the front cover of the picture making apparatus or book, must be supported either by the child or on a relatively large work surface, thus rendering the apparatus impractical for use on certain occasions, such as when the child is seated in a vehicle.

Other known stencil books and stencil kits do not include both stencils and drawing sheets bound together in a single book. For example, U.S. Pat. No. 4,931,017 discloses a stencil book having a plurality of successive stencil sheets. A sheet of paper on which stenciling can be performed is insertable beneath a selected stencil page.

### SUMMARY OF THE INVENTION

The invention provides a stenciling device in which a plurality of stencil sheets and a plurality of removable drawing sheets are bound together in a book. The device holds a plurality of stencils and drawing sheets together in a unitary, compact format that can be easily manipulated, handled and held by a child, and which allows multiple uses of each of the stencils, and/or allows completed drawings to be easily removed, all without adult supervision.

In accordance with an aspect of this invention, a stenciling device includes a plurality of stencil pages and one or more drawing pages, wherein the stencil pages and drawing pages are bound together.

In accordance with another aspect of the invention, a stenciling device includes a plurality of stencil pages and a plurality of drawing pages, wherein the drawing pages include a line of perforations adjacent the bound edge of the device or book which allows the individual drawing pages to be easily removed by tearing along the line of perforations.

These and other features, advantages and objects of the present invention will be further understood and appreciated by those skilled in the art by reference to the following specification, drawings and claims.

### BRIEF DESCRIPTION OF THE DRAWINGS

FIG. 1 is a perspective view of a stenciling device in accordance with the principles of this invention.

### DESCRIPTION OF THE PREFERRED EMBODIMENTS

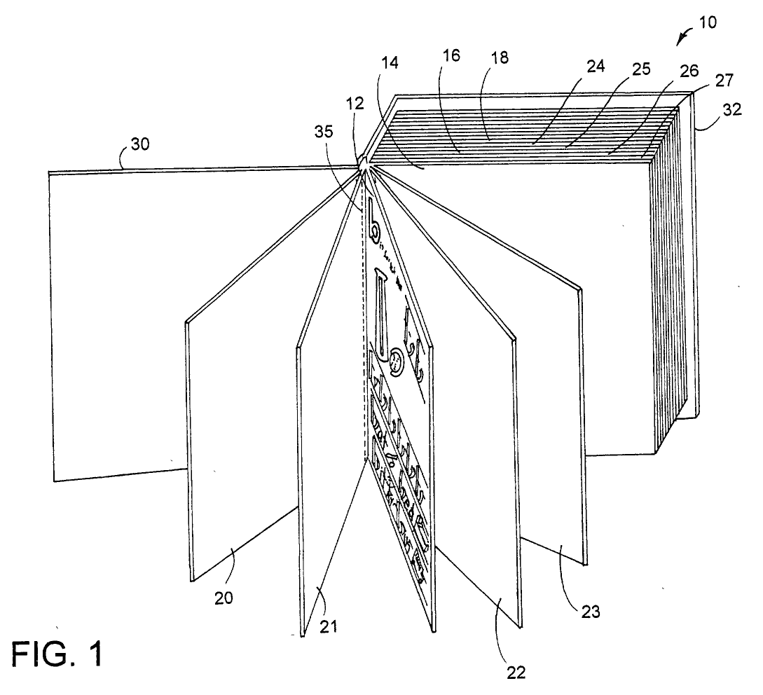

Shown in FIG. 1 is a perspective view of a stenciling device or book 10 in accordance with the invention. Stenciling book 10 includes a plurality of stencil pages 12, 14, 16 and 18, and at least one drawing page 20, 21, 22, 23, 24, 25, 26 and 27 bound adjacent one of the stencil pages. Preferably, two or more drawing pages are bound adjacent each stencil page to allow multiple uses of each of the stencils on a plurality of drawing sheets bound in device or book 10.

Book 10 includes a front cover 30, and a back cover 32. Front and back covers 30 and 32 are preferably made of a relatively stiff and thick material which is suitable for use as a support surface for drawing.

Each of the stencils sheets is die-cut to provide a different stencil to permit stenciling of desired drawings, geometric shapes, letters, numbers, etc. onto a drawing page 20-27. The stencils are preferably made of a relatively thick and stiff or rigid material that will allow multiple uses and withstand the forces exerted upon the edges of the stencil sheets by a writing implement during stenciling. Preferred materials for stencil pages 12-18 include cardboard, various plastic materials, and laminates (e.g., cardboard or paper sheet having one or both sides laminated with a layer of plastic material).

Drawing pages 20-27 may be blank, lined, or partially printed. For example, the drawing pages could include preprinted matter, including instructions, drawings, partial drawings, etc., with other blank areas upon which stenciling is performed. The drawing sheets 20-27 may be made of any material having attributes and characteristics suitable for receiving drawings and/or writing from a writing implement. Preferably, the drawing pages are receptive to ink, graphite and other writing materials from pencils, crayons and the like. Preferably, drawing pages 20-27 are paper.

Drawing pages 20-27 include a line of perforations 35 adjacent the edge of the pages which is bound, to facilitate easy removal of a drawing page from book 10, if desired, upon completion of a drawing.

While book 10 is primarily intended for educating and/or amusing children, device 10 may also be used by adults, with specific examples including training at drawing foreign language characters (e.g., Chinese or Japanese).

Unlike known stencil books requiring difficult manipulation, large work surfaces, and/or separate drawing sheets and stencils, device 10 is easily manipulated and includes both stencils and drawings sheets bound together in a single book. The invention allows a child or other person to select a desired stencil design from a plurality of different stencils bound together in the book, and immediately begin stenciling on a drawing sheet bound adjacent to the selected stencil. After the stenciling has been completed, the stencil page can be flipped aside and the drawing may be elaborated upon by adding additional features, coloring, words, etc. When the drawing is complete, the drawing page 20-27 may be easily removed by tearing along the line of perforations 35. Preferably, at least two drawing sheets are disposed adjacent each stencil whereby each stencil may be used a plurality of times, thus allowing a child to make a plurality of different drawings with the same stencil, or allowing different children to make drawings with the same stencil.

The devices in accordance with an aspect of this invention bind stencil sheets and drawing sheets together in a book, whereby any need for separately searching for stencils and/or drawing sheets is eliminated. In accordance with another aspect, the invention holds the stencil sheets in superposition with a drawing sheet, whereby the need for positioning and holding the drawing sheets in proper superposition for stenciling is eliminated.

In another aspect, a line of perforations allows drawing sheets to be easily removed as desired.

The above description is considered that of the preferred embodiments only. Modifications of the invention will occur to those skilled in the art and to those who make or use the invention. Therefore, it is understood that the embodiments described above are merely for illustrative purposes and not intended to limit the scope of the invention, which is defined by the following claims as interpreted according to the principles of patent law, including the doctrine of equivalents.

The invention claimed is:

1. A stenciling device comprising:
a plurality of bound pages, including one or more stencil pages, and one or more drawing pages, at least one drawing page being bound adjacent to each stencil page.

2. The device of claim 1, wherein the drawing pages are paper.

3. The device of claim 1, wherein the stencil pages are cardboard.

4. The device of claim 1, wherein the stencil pages are plastic.

5. The device of claim 1, wherein the stencil sheet is a laminate comprising a paper or cardboard layer and one or more plastic layers.

6. The device of claim 1, wherein the stencil patterns of the stencil pages are die-cut.

7. The device of claim 1, wherein a plurality of successive drawing pages are bound adjacent each stencil, whereby each stencil may be used for successively stenciling on each of the plurality of drawing pages.

8. The device of claim 1 having at least two drawing pages bound adjacent a stencil page.

9. A stenciling device comprising:
a plurality of pages bound together, including one or more stencil pages, and one or more drawing pages, wherein the drawing pages include a line of perforations adjacent the edge of the page that is bound, whereby the drawing pages may be easily removed from the device.

10. The device of claim 9, wherein the drawing pages are paper.

11. The device of claim 9, wherein the stencil pages are cardboard.

12. The device of claim 9, wherein the stencil pages are plastic.

13. The device of claim 9, wherein the stencil sheet is a laminate comprising a paper or cardboard layer and one or more plastic layers.

14. The device of claim 9, wherein the stencil patterns of the stencil pages are die-cut.

15. The device of claim 9, wherein a plurality of successive drawing pages are bound adjacent each stencil, whereby each stencil may be used for successively stenciling on each of the plurality of drawing pages.

16. The device of claim 9 having at least two drawing pages bound adjacent a stencil page.
